(19) United States
(12) Patent Application Publication
(10) Pub. No.: US 2016/0062688 A1
(43) Pub. Date: Mar. 3, 2016

(54) FLASH MEMORY DEVICE, FLASH MEMORY SYSTEM, AND OPERATING METHOD

(71) Applicant: SAMSUNG ELECTRONICS CO., LTD., SUWON-SI (KR)

(72) Inventors: OH CHUL KWON, SEOUL (KR); SANG HOON LEE, SUWON-SI (KR)

(21) Appl. No.: 14/744,104

(22) Filed: Jun. 19, 2015

(30) Foreign Application Priority Data
Sep. 3, 2014 (KR) 10-2014-0117023

(51) Int. Cl. G06F 3/06

(52) U.S. Cl. CPC G06F 3/0619; G06F 3/0644; G06F 3/0679

(57) ABSTRACT

A flash memory device includes: a memory unit that includes a cell area that has one or more memory blocks each including a plurality of pages; a page buffer that includes a valid data area storing valid data to be programmed to the pages and a pad area storing non-valid data to be programmed to the pages, in response to an external data program command for the one or more pages; and a control logic that retains the non-valid data stored in the pad area and stores the valid data in the valid data area, in response to the data program command.

### CROSS-REFERENCE TO RELATED APPLICATION

This application claims the benefit of Korean Patent Application No. 10-2014-0117023 filed on Sep. 3, 2014, the subject matter of which is hereby incorporated by reference.

### BACKGROUND

The inventive concept relates generally to flash memory devices, flash memory systems, and operating methods for same. More particularly, the inventive concept relates to flash memory devices, flash memory systems, and operating methods thereof, capable of programming data to a page in memory according to valid data loaded in a valid data area of a page buffer and non-valid data loaded in a pad area of the page buffer.

With the development of mobile systems and various application systems, a demand for a flash memory device operating as a non-volatile memory has increased. The flash memory device is a non-volatile memory that is electrically erasable and programmable. The flash memory device retains data even when power is interrupted. The flash memory device has low power consumption, as compared to a storage medium based on a magnetic disk memory. In addition, the flash memory device has an access time that is as fast as a hard disk.

Due to a page layout characteristic of the flash memory device, areas other than an area in which data is stored are left in such a state that data is not stored. Such areas are an obstacle to program and read operations of the flash memory device due to F-poly coupling, resulting in an increase in the error occurrence probability of the flash memory device.

### SUMMARY

The inventive concept provides a flash memory device, a flash memory system, and an operating method thereof, which are capable of preventing F-poly coupling occurring in a page area in which data is not stored and improving the performance thereof.

According to an aspect of the inventive concept, there is provided a flash memory device including: a memory unit that includes a cell area that has one or more memory blocks each including a plurality of pages; a page buffer that includes a valid data area storing valid data to be programmed to the pages and a pad area storing non-valid data to be programmed to the pages, in response to an external data program command for the one or more pages; and a control logic that retains the non-valid data stored in the pad area and store the valid data in the valid data area, in response to the data program command.

The valid data may include user data necessary for a program or read operation and a parity bit necessary for error detection.

The control logic may program the non-valid data to at least one memory cell corresponding to the pad area, such that a state of the at least one memory cell is changed to off-cell.

The control logic may control an operation of storing first data in the valid data area and second data in the pad area in a first program operation and may program the first data to at least one memory cell of a first page among the plurality of pages corresponding to the valid data area, and program second data to at least one memory cell of the first page corresponding to the pad area.

The control logic may control an operation of storing third data in the valid data area in a second program operation and may program third data to at least one memory cell of a second page among the plurality of pages corresponding to the valid data area, and program the second data to at least one memory cell of the second page corresponding to the pad area.

The control logic may clear data stored in the valid data area and the pad area in an erase operation of the memory unit.

A read page among the plurality of pages may store first data corresponding to the valid data and second data corresponding to the non-valid data, and the control logic may control an operation of storing the first data of the read page in the valid data area and the second data of the read page in the pad area during a read operation.

The control logic may erases data stored in the valid data area and the pad area when an erase operation is performed on the at least one memory block.

According to another aspect of the inventive concept, there is provided a flash memory system including: a flash memory device that includes a memory cell array with a plurality of memory blocks; and a memory controller that controls program, read, and erase operations of the flash memory device, generates first program data including first valid data and non-valid data in response to a first data program request from an external host with respect to one or more pages, and transmits the first program data and a first data program command to the flash memory device.

The memory controller may include a NAND layer having software for controlling the flash memory device.

The memory block may include at least one page, the at least one page may include a first area to which the first valid data is programmed and a second area to which the non-valid data is programmed, and the second area may be an area of the page that is not mapped by an address received from the external host.

The non-valid data may have a data value that changes a state such that at least one memory cell included in the second area becomes off-cell.

The flash memory device may further include a page buffer that has a valid data area and a pad area.

The first valid data may be stored in the valid data area, the non-valid data may be stored in the pad area, and the memory controller may generate second program data including second valid data in response to a second data program request from the external host with respect to the one or more pages, and transmit the second program data and a second data program command to the flash memory device.

The valid data area may store the second valid data and the pad area may retain the stored non-valid data, based on the second data program command.

### BRIEF DESCRIPTION OF THE DRAWINGS

Embodiments of the inventive concept will be more clearly understood from the following detailed description taken in conjunction with the accompanying drawings in which:

FIG. 1 is a block diagram of a flash memory system according to an embodiment of the inventive concept;

FIG. 2, inclusive of FIGS. 2A and 2B, further illustrates the page buffer and memory unit of FIG. 1;

FIG. 3, inclusive of FIGS. 3A, 3B, 3C and 3D, is a conceptual diagram illustrating a program operation executed in the page buffer of FIG. 1;

FIG. 4, inclusive of FIGS. 4A and 4B, is a conceptual diagram illustrating a program operation executed by the flash memory device of FIG. 1;

FIG. 5 is a conceptual diagram illustrating a read operation of a flash memory device;

FIG. 6 is a block diagram illustrating a flash memory system according to another embodiment of the inventive concept;

FIG. 7, inclusive of FIGS. 7A, 7B, and 7C, is a conceptual diagram illustrating types of program data that may be generated by the memory controller of FIGS. 1 and 6;

FIG. 8 is a block diagram illustrating a copy operation between memory blocks in a flash memory device;

FIGS. 9, 10 and 11 are respective flowcharts variously summarizing methods of operating a flash memory system according to embodiments of the inventive concept;

FIG. 12 is a block diagram illustrating a computer system including a flash memory device according to an embodiment of the inventive concept;

FIG. 13 is a block diagram illustrating a memory card according to an embodiment of the inventive concept;

FIG. 14 is a block diagram illustrating a semiconductor storage system (e.g., a solid state drive or SSD) according to an embodiment of the inventive concept; and

FIG. 15 is a conceptual diagram illustrating a server and network system including a semiconductor storage system incorporating one or more embodiments of the inventive concept.

### DETAILED DESCRIPTION

Hereinafter, embodiments of the inventive concept will be described with reference to the accompanying drawings. The inventive concept may, however, be embodied in many different forms and should not be construed as being limited to the embodiments set forth herein; rather, these embodiments are provided so that this disclosure will be thorough and complete, and will fully convey the inventive concept to those of ordinary skill in the art. It should be understood, however, that there is no intent to limit the inventive concept to the particular forms disclosed, but on the contrary, the inventive concept is to cover all modifications, equivalents, and alternatives falling within the spirit and scope of the inventive concept. Like reference numerals denote like elements throughout the specification and drawings. In the drawings, the dimensions of structures are exaggerated or reduced for clarity of the inventive concept.

The terms used in the present specification are merely used to describe particular embodiments, and are not intended to limit the inventive concept. As used herein, the singular forms “a”, “an”, and “the” are intended to include the plural forms as well, unless the context clearly indicates otherwise. It will be understood that the terms such as “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof.

Though terms like “first” and “second” are used to describe various elements, the elements are not limited to these terms. These terms are used only to differentiate one element from another. Therefore, a first element may be referred to as a second element, and similarly, a second element may be referred to as a firs element, without departing from the scope of the inventive concept.

Unless otherwise defined, all terms used herein, including technical and scientific terms, have the same meaning as commonly understood by one of ordinary skill in the art to which the inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “and/or” includes any and all combinations of one or more of the associated listed items. Expressions such as “at least one of” when preceding a list of elements, modify the entire list of elements and do not modify the individual elements of the list.

Figure (FIG.) 1 is a block diagram illustrating a flash memory device 1200 configured in a flash memory system 1000 according to an embodiment of the inventive concept. Hereinafter, a particular type of program operation causing data to be stored in certain portions of a page buffer and in certain memory cells areas of a memory unit in the flash memory device 1200 will be referred to as a “store operation” in order to distinguish this type of operation from other program operations that cause data to be stored in other portions of the page buffer and in other memory cells areas of the memory unit.

In this regard, some portion(s) (e.g., memory cells, flip-flops, register portions, etc.) of a page buffer will be designated as valid data area(s), and other portion(s) of the page buffer will be designated as pad area(s). In like manner, some portion(s) of (i.e., memory cells) of a memory page of a memory unit will be designated as first area(s), and other portion(s) of the memory page will be designated as second area(s). Here, a first area may be understood as an area of a designated page that is identifiably (i.e., can be mapped) in relation to an address externally provided to the flash memory. In contrast, a second area may be understood as an area of a designated page that is not identifiably (i.e., cannot be mapped) in relation to an address externally provided to the flash memory. Thus, it may be readily understood that valid data will not be programmed to a second area of a designated page in memory, and valid data will not be loaded, stored by and/or unloaded from a pad area of a page buffer. Only non-valid data is stored in the pad area, and only non-valid data is programmed to a second area corresponding to the pad area. From another perspective, a pad area of a page buffer may be understood as an area that is not loaded with valid data received from a host during a programming operation.

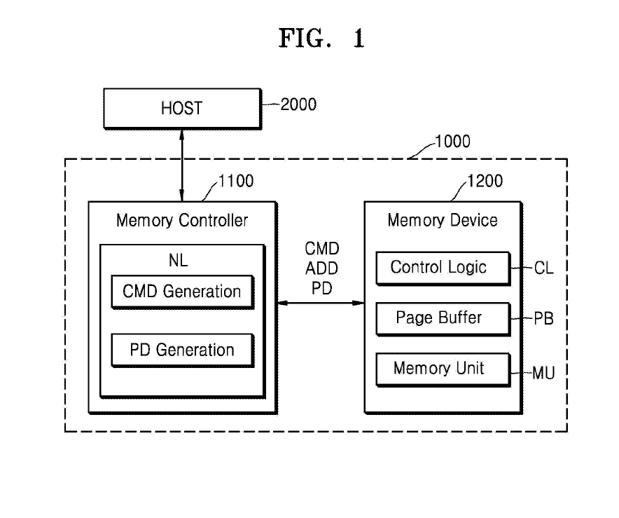

The flash memory system 1000 of FIG. 1 comprises the flash memory device 1200 and a memory controller 1100, where the memory controller 1100 controls the overall execution of various operations by the flash memory device 1200 including program, read, and erase operations. The flash memory device 1200 includes at least control logic (CL), a memory unit (MU), and the page buffer (PB), where the control logic controls the execution of program, read, and erase operations by the flash memory device 1200 in response to command(s) (CMD), address(es) and/or data (such as program data PD) received from the memory controller 1100.

As is typical of flash memory devices, the memory unit (MU) of the flash memory device 1200 is divided (logically and/or physically) into multiple memory blocks, where each memory block is further divided (logically and/or physically) in a number of pages. In view of the foregoing, the memory cells constituting a “page of memory” (or more simply a “page”) in the memory unit of a flash memory device may be understood as including: (1) first memory cells arranged in first area(s) and designated to receive and store valid data, and (2) second memory cells arranged in second area(s) and designated to receive and store only non-valid data. Here, the term “valid data” refers to many different types of data (e.g., user data, programming code, control data, error detection and/or correction data, etc.) having meaning within the context of one or more programs (e.g., an operating system, control program, application, etc.) causing data to be stored in the flash memory device 1200. In contrast, the term “non-valid data” refers to data not having a defined meaning within the context of one or more programs causing data to be stored in the flash memory device 1200.

Hence, in relation to certain embodiments of the inventive concept, non-valid data temporarily stored in a pad area of a page buffer will be programmed memory cells of a designated page corresponding to the pad area. Here, the non-valid data may have a set value or defined pattern. For example, non-valid data programmed to a memory cell may cause the memory cell to exhibit an OFF cell state.

The components shown in FIG. 1 may be variously and differently configured with embodiments of the inventive concept. For example, the memory controller 1100 and flash memory device 1200 may be implemented using separate semiconductor chips or separate semiconductor devices. The flash memory system 1000 may be implemented as a memory card, such as a secure digital (SD) or a multimedia card (MMC). Alternately, the flash memory system 1000 and host 2000 may be connected via one or more conventionally understood interface(s), such as Advanced Technology Attachment (ATA), Serial Advanced Technology Attachment (SATA), Universal Serial Bus (USB), Small Computer System Interface (SCSI), Enhanced Small Device Interface (ESDI), Peripheral Component Interconnect-Express (PCI-E), and/or Intelligent Drive Electronics (IDE) interface. The host 2000 may be one of many different types of devices configured to use the flash memory system 1000, such as a personal digital assistant (PDA), a computer, a digital audio player, a digital camera, a mobile terminal, or the like.

Unlike other types of storage devices (e.g., a hard disk), the flash memory device 1200 requires special data management approaches to the programming, reading, and/or erasing of data. For example, data is usually erased from a flash memory system on a memory block by memory block basis, while data is programmed to and read from the flash memory system on a page by page basis. Further, data stored in a flash memory device may not by directly overwritten, but must first be erased and then re-programmed with new data.

Flash memory devices are most commonly provided in the form of a NAND flash memory or a NOR flash memory, depending on the specific configuration of memory cells. NAND flash memory has become extensively used in many contemporary applications. In a NAND flash memory systems, a so-called NAND layer (NL) is provided, usually at the memory controller level. The NAND layer is essentially specialized software controlling the operation of the flash memory device 1200. The NAND layer may be loaded into a Random Access Memory (RAM) (not shown in FIG. 1) and used by the memory controller 1100 during the operation of the flash memory device 1200 to drive various operations of the flash memory device 1200.

As conceptually shown in FIG. 1, the NAND layer may include at least one software module that drives the flash memory device 1200. For example, the NAND layer may include a command generation module and a program data generation module. The command generation module may control an operation of storing non-valid data in the pad area, and the program data generation module may generate program data including valid data and non-valid data. When a memory operation is requested by the host 2000, the memory controller 1100 may load the NAND layer into the RAM or register under the control of a processor (not shown in FIG. 1) and control execution of the memory operation by use of the NAND layer.

According to certain embodiments of the inventive concept, the command generation module of FIG. 1 may be used to generate one or more command(s) (CMD) associated with one or more operation(s) accessing (e.g., programing, reading or erasing) data stored in, or to-be-stored in the memory unit of the flash memory device 1200. Using this approach and under the control of the memory controller 1100, non-valid data may be loaded to and stored (i.e., retained in) designated pad area(s) of the page buffer. Then, during the execution of a program operation, the non-valid data will be transferred from the pad area(s) of the page buffer to corresponding memory cells of second area(s) of the page designated by the program operation.

In this context, the page is assumed to be the basis unit of data identified during the program and read operations executed by the flash memory system 1000. The definition of a page may vary. For example, a page may include a group of flash memory cells commonly connected to a word line or a selection line. The program data generation module of FIG. 1 may be used to generate program data based on a given page size.

In view of embodiments of the inventive concept, the program data will include both valid data and non-valid data. For example, certain valid data may include user data received from the host 2000, as well as error detection and/or correction data (e.g., parity data) corresponding to the user data and generated by the memory controller 1100 upon receipt of the valid data. Non-valid data may be generated by the memory controller 1100.

Thus, in the context of the illustrated example of FIG. 1, at least one of the command generation module and program data generation unit will be enabled during a program operation to provide non-valid data to pad area(s) of a page buffer. Valid data may also be provided to valid data areas of the page buffer.

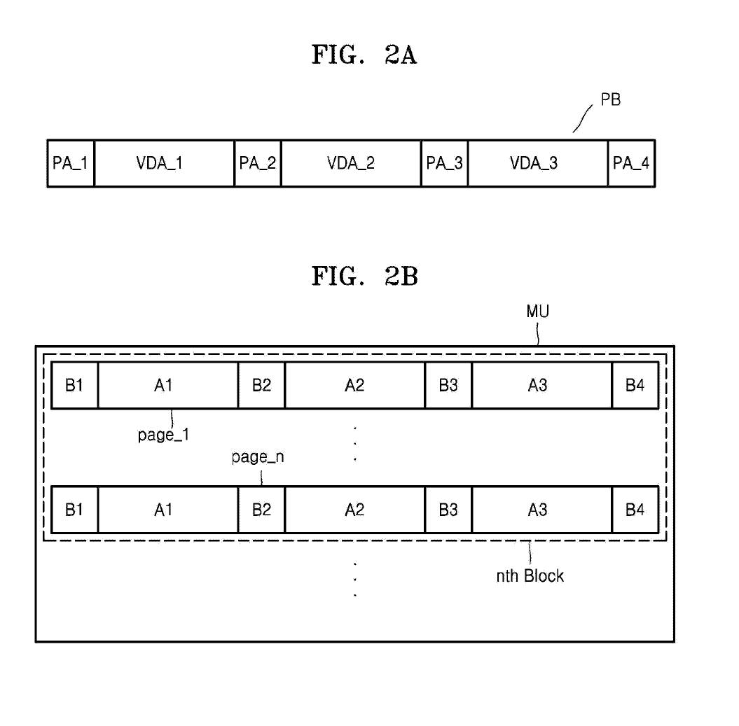

FIG. 2, inclusive of FIGS. 2A and 2B, further illustrates in one example the flash memory device 1200 of FIG. 1, where FIG. 2A is a conceptual diagram illustrating the page buffer (PB) of FIG. 1 and FIG. 2B is another conceptual diagram illustrating the memory unit (MU) of FIG. 1.

The page buffer shown in FIG. 2A includes first, second and third “valid data areas” (VDA_1, VDA_2, and VDA_3), as well as first, second, third and fourth “pad areas” (PA_1, PA_2, PA_3 and PA_4). However, the scope of the inventive concept is not limited to only this illustrated example of FIG. 2A. Here, however, the respective pad areas may have various sizes, numbers, and positions may be formed according to the size, address, etc.

The memory unit illustrated in FIG. 2B includes multiple memory blocks including an nth memory block, where the nth memory block includes ‘n’ pages (page_1 through page_n). The first page (page_1)—consistent with the arrangement of the page buffer shown in FIG. 2A—includes memory cells designated as “first areas” (A1, A2 and A3) respectively corresponding to first, second and third valid data areas (VDA_1, VDA_2, and VDA_3), and memory cells designated as “second areas” (B1, B2, B3 and B4) respectively corresponding to first, second, third and fourth pad areas (PA_1, PA_2, PA_3 and PA_4). The other pages of the exemplary nth memory block shown in FIG. 2B may have the same configuration definition as the first page (page_1). However, the scope of the inventive concept is not limited to the illustrated example of FIG. 2B, and the respective second areas may have various sizes, numbers, and positions formed in accordance with the size, address, arrangement, etc. of the first areas.

Recognizing that the valid data areas and pad areas of a constituent page buffer (PB) may be variously arranged, and for convenience of description, any number and/or arrangement of valid data areas (e.g., VDA_1, VDA_2, and VDA_3) will singularly or collectively be referred to as a valid data area, while any number and/or arrangement of pad areas (e.g., (PA_1, PA_2, PA_3 and PA_4) will be singularly or collectively referred to as a pad area. Similarly, recognizing that the first and second areas of a constituent memory unit (MU) may be variously arranged, and for convenience of description, any number and/or arrangement of first areas (e.g., A1, A2 and A3) will be singularly or collectively referred to as a first area, while any number and/or arrangement of second areas (e.g., B1, B2, B3 and B4) will be referred to as a second area.

Regardless of particular page buffer configuration and/or page layout in the memory unit, valid data may be loaded to, stored in, and/or unloaded from any one or more of the valid data areas of the page buffer during the programming of the memory cells in any one or more of the first areas of a designated page of the memory unit (e.g., the first page—page_1). In contrast, non-valid data may be loaded to, stored in and/or unloaded from any one or more pad area during programming of the memory cells in any one or more of a second area of the designated page of the memory unit.

In the context of the term “page” it should be noted that the embodiments of the inventive concept may be applied to flash memory device including a memory area arranging memory cells configured to operate as single-level memory cells (SLC) capable of storing one bit of data per memory cell and/or multi-level memory cells (MLC) capable of storing two or more bits of data per memory cell.

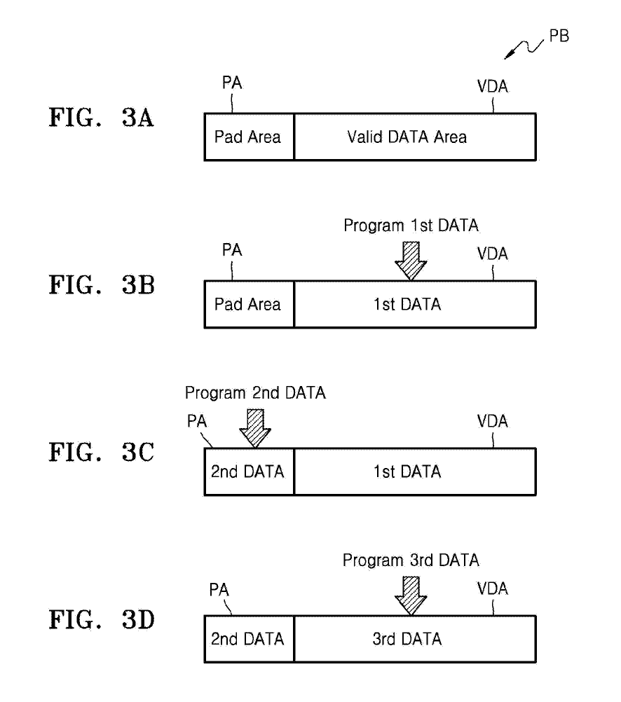

FIG. 3, inclusive of FIGS. 3A, 3B, 3C and 3D, is a conceptual diagram illustrating the data loading of a page buffer (PB) (i.e., a store operation) during a program operation according to an embodiment of the inventive concept. Consistent with the foregoing description with reference to FIG. 1, it is assumed that the command generation module is enabled to facilitate the store operation.

FIG. 3A illustrates receipt of a clear (or erase) operation command from the memory controller 1100 that clears data from the page buffer. At this time, a pad area (PA) and a valid data area (VDA) are placed in a non-programmed state. Then, in FIG. 3B the control logic of the flash memory device 1200 receives a first program operation command along with first program data (DATA) from the memory controller 1100. Here, the first program data is assumed to be valid data. The control logic causes the first program data to be loaded (or stored) in the valid data area of the page buffer.

Next, in FIG. 3C, the control logic of the flash memory device 1200 causes second program data to be loaded to the pad area of the page buffer. Here, the second data is assumed to be non-valid data. As such, the second program data may be generated by the control logic of the flash memory device 1200 or provide by the memory controller 1100. For example, a command generated by operation of the command generation module may be used to cause the flash memory device 1200 to generate the second program data. Once the first program data and second program data have been loaded into the page buffer using this approach, the first area of a designated page in memory may be programmed with the first program data stored in the valid data area, and a second area of the designated page may be programmed with the second program data stored in the pad area.

Following programing of the designated page in memory and as shown in FIG. 3D, the control logic of the flash memory device 1200 may receive a second program operation command along with third program data from the memory controller 1100. Here, the third program data is assumed to be valid data, but the control logic of the flash memory device 1200 may skip the clear (erase) operation for the page buffer PB, and may store the third program data in the valid data area of the page buffer. Further, since the second program data is retained in the pad area, it is possible to avoid the re-loading of data to the pad area, thereby improving the overall performance of the flash memory device 1200 and flash memory system 1000.

As described above with reference to FIG. 1, a case where the command generation module and the program data module are operated will now be described with reference to FIG. 3.

Again, FIG. 3A illustrates the clearing of the page buffer (PB) in response to a clear (or erase) operation command received from the memory controller 1100. Thus, the pad area (PA) and valid data area (VDA) are placed in a not programmed state. Referring again to FIGS. 3B and 3C, the control logic of the flash memory device receives a first program operation command along with the first program data from the memory controller 1100. The first program data is valid data, and non-valid second data may be generated in response to the first program operation command. The control logic loads the first program data into the valid data area of the page buffer and the second program data into the pad area of the page buffer. Here, the first and second program data may be sequentially loaded in the page buffer in a prescribed order or the first and second program data may be loaded in parallel.

Following the programming of the first and second program data to a designated page and referring to FIG. 3D, the control logic of the flash memory device 1200 may receive a second program operation command and corresponding third program data from the memory controller 1100. By disabling the program data generation module of FIG. 1, the third program data need not be processed to generate or load non-valid data, unlike the approach described in relation to the first program data. Rather, the control logic may skip the erase operation for the page buffer PB, and merely store the third program data in the valid data area. Since the second program data is retained in the pad area of the page buffer, it is possible to avoid the steps required to load non-valid data into the pad area of the page buffer, thereby improving the performance of the flash memory device 1200 and flash memory system 1000.

In this manner, the operation of the control logic of the flash memory device 1200 may be controlled by the memory controller 1100.

FIG. 4, inclusive of FIGS. 4A and 4B, is a conceptual diagram illustrating the execution of a program operation by the flash memory device 1200 of FIG. 1.

Referring to FIGS. 1 and 4A, the flash memory device 1200 is again assumed to include the control logic (CL), page buffer (PB), and memory unit (MU). As already described in relation to FIG. 3, the page buffer may load valid (first) data into valid data area(s) and non-valid (second) data into pad area(s). Here, as before, the memory unit is assumed to include a first page (page_1) including memory cells in a designated first area corresponding to the valid data area of the page buffer, and memory cells in a designated second area corresponding to the pad area of the age buffer.

The control logic may provide a first control signal (PC1) to the page buffer to control the programming of the first data loaded in the valid data area of the page buffer to the memory cells of the first area of the first page, and the programming second data loaded in the pad area of the page buffer to the memory cells of the second area of the first page.

As illustrated in FIG. 4B, as described above with reference to FIG. 3D, the valid data area (VDA) of the page buffer may next be loaded with (valid) third program data associated with a second program operation command, whereas the second (non-valid) program data may be retained in the page area of the page buffer. Here, the memory unit includes a second page (page_2) having a first area that corresponds to the valid data area of the page buffer, and a second area that corresponds to the pad area of the page buffer.

The control logic provides a second control signal (PC2) to the page buffer, and in response the control logic of the flash memory device 1200 causes the third program data stored in the valid data area to be programmed to the first area of the second page, and the second data stored in the pad area to be programmed to the second area of the second page.

In this manner, the program data, including both valid data and invalid data, may be more efficiently programmed to memory cells of a designated page of the memory unit, without necessarily repeating the operational steps required to load non-valid data in pad area(s) of a page buffer PB, thereby improving the performance of the flash memory device. As described above with reference to FIG. 1, it is also possible to reduce the occurrence of bit errors in the programming of the flash memory device by retaining non-valid data in portion(s) of the page buffer, wherein the programming of the non-valid data to second area(s) of a designated page causes the constituent memory cells to exhibit an OFF cell state.

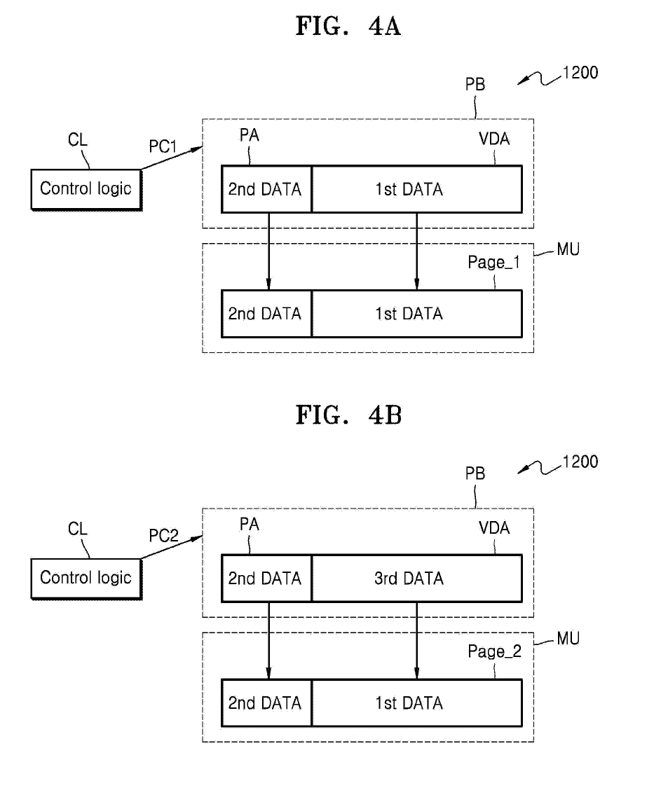

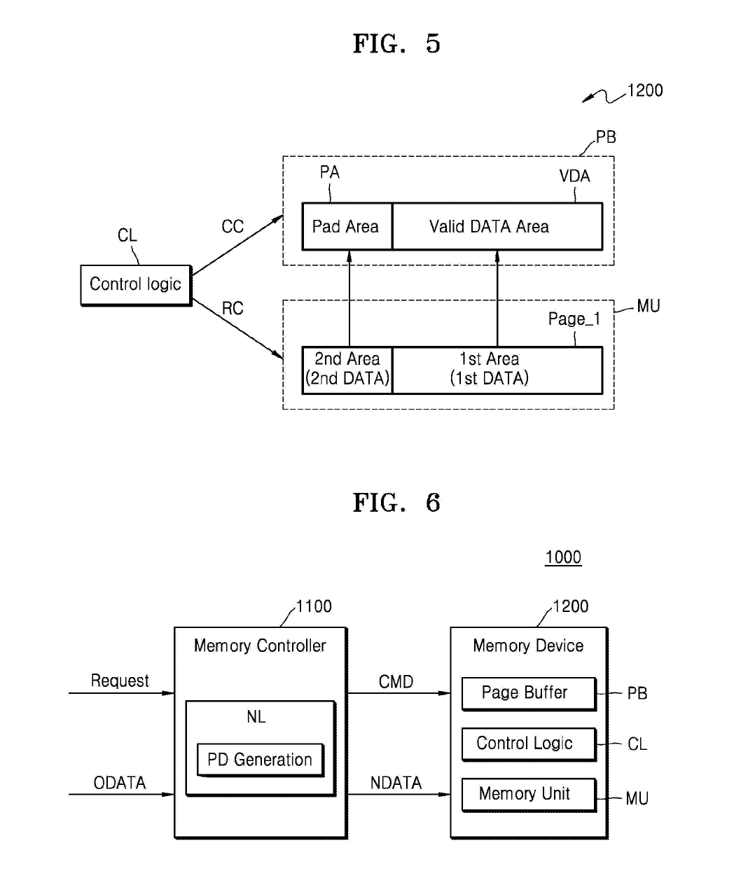

FIG. 5 is a conceptual diagram illustrating the execution of a read operation by the flash memory device 1200 of FIG. 1.

Referring to FIG. 5, when a data read command is received from the memory controller 1100, the control logic (CL) of the flash memory device 1200 provides a clear signal (CC) to the page buffer (PB) in order to clear stored data from the page buffer. Here again, the memory unit (MU) is assumed to include a first page (page_1) having a first area of memory cells to which first (valid) data is programmed, and a second area of memory cells to which second (non-valid) data is programmed. In response to a read signal RC received from the control logic of the flash memory device 1200, the memory unit causes first data stored in the first area of the first page to be loaded in the valid data area of the page buffer and second data stored in the second area of the first page to be loaded in the pad area of the page buffer.

FIG. 6 is a block diagram illustrating in another example the flash memory system 1000 according to certain embodiments of the inventive concept.

Referring to FIG. 6, the flash memory system 1000 again includes a memory controller 1100 and flash memory device 1200. As described above with reference to FIG. 1, the memory controller 1100 includes a NAND layer (NL) including a program data generation module, and the flash memory device 1200 includes a page buffer (PB), control logic (CL), and a memory unit (MU).

The memory controller 1100 receives a data program request (REQUEST) and valid, external program data (ODATA) from (e.g.,) a host. In response, internal program data (NDATA), including both non-valid data and valid data, as generated by the operation of the program data generation module. The valid data may include the external program data as well as other information derived from or related to the external program data (e.g., error detection and/or correction data). The memory controller 1100 then provides the flash memory device 1200 with the internal program data and a program operation command (CMD) to cause the programming of the internal program data, per (e.g.,) the description provided above in relation to FIG. 3.

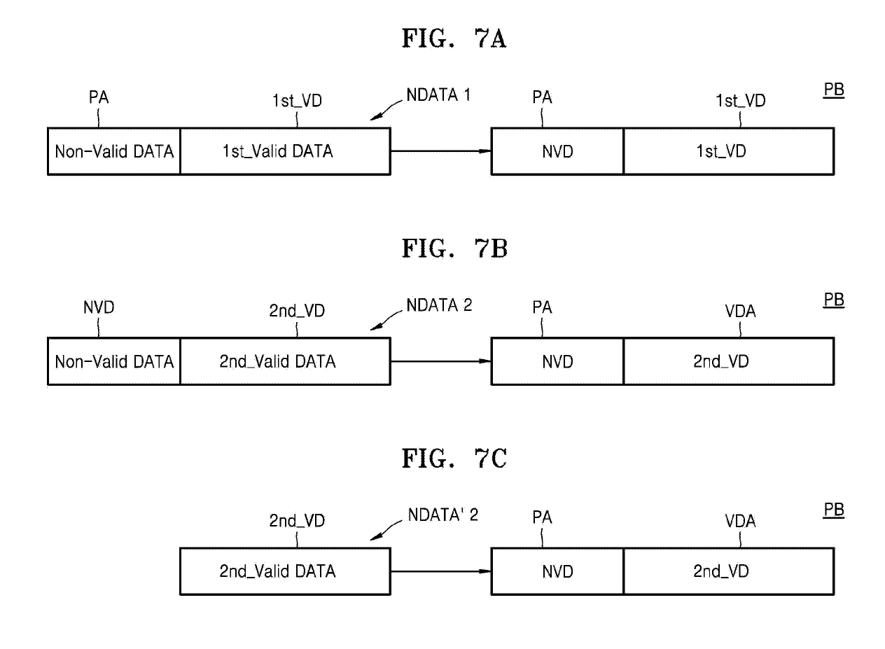

FIG. 7, inclusive of FIGS. 7A, 7B, and 7C, illustrates various types of program data that may be generated by the memory controller 1100 of FIG. 6.

Referring to FIG. 7A, upon reception of a first data program request, the memory controller 1100 may be used to generate first program data NDATA1 including non-valid data NVD and first valid data 1st_VD by the operation of the program data generation module. A data value of the non-valid data NVD may be determined by the operation of the program data generation module. The first program data NDATA1 may be provided to the flash memory device 1200 such that the non-valid data NVD and the first valid data 1st_VD are stored in the pad area and the valid data area of the page buffer, respectively.

Referring to FIG. 7B, upon reception of a second data program request, the memory controller 1100 may be used to generate second program data NDATA2 including non-valid data NVD and second valid data 2nd_VD by the operation of the program data generation module. The non-valid data NVD may be generated by the program data generation module. The second program data NDATA2 may be provided to the flash memory device 1200 such that the non-valid data NVD and the second valid data 2nd_VD are stored in the pad area and the valid data area of the page buffer, respectively.

Referring to FIG. 7C, upon reception of the second data program request following the steps shown in FIG. 7A, the memory controller 1100 need not necessarily determine values for the non-valid data NVD and may instead merely generate second program data NDATA′2 including second valid data 2nd_VD without including the non-valid data NVD. By providing the second program data NDATA′2 to the flash memory device 1200, the non-valid data NVD retained in the pad area of the page buffer (as provided for by the steps shown in FIG. 7A) while the second valid data 2nd_VD included in the second program data NDATA′2 may be stored in the valid data area. The respective operations described with reference to FIGS. 7A, 7B, and 7C may be controlled according to command(s) provided by the memory controller 1100 and by the control logic CL of the flash memory device 1200.

In FIG. 7C, the non-valid data generated in FIG. 7A and stored in the page buffer PB is not again generated, and the non-volatile data stored in the pad area is retained. In this manner, the repetitive operation of storing data in the pad area is avoided, thereby improving the overall performance of the flash memory device 1200 and flash memory system 1000.

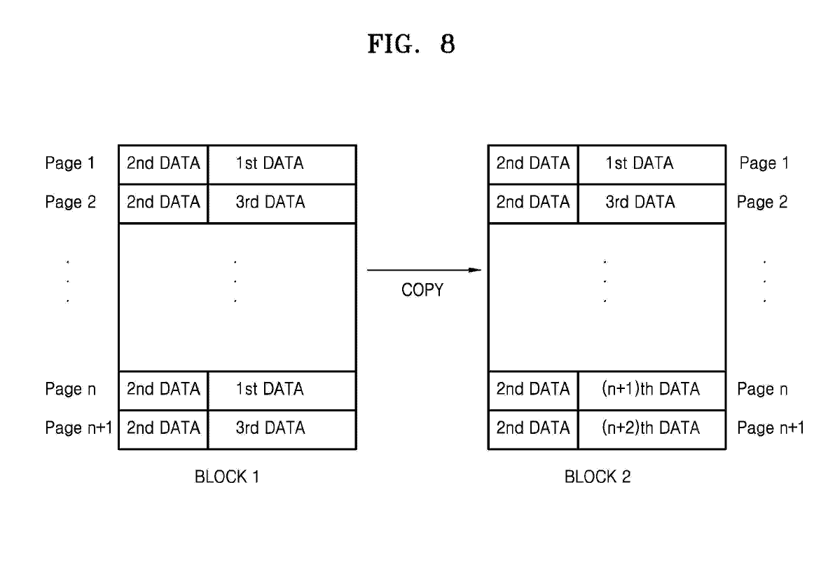

FIG. 8 is a block diagram illustrating execution of a copy operation between memory blocks of a flash memory device according to an embodiment of the inventive concept.

Referring to FIGS. 1 and 8, the flash memory device 1200 includes a first memory block BLOCK1 and a second memory block BLOCK2. First data corresponding to valid data may be programmed to memory cells corresponding to a first area of a first page of the first memory block BLOCK1, and second data corresponding to non-valid data may be programmed to memory cells corresponding to a second area thereof. As such, valid data may be stored in memory cells corresponding to first areas of second to nth pages except for the first page, and non-valid data may be stored in memory cells corresponding to second areas thereof. The second data programmed to the memory cells of the second areas of the first to nth pages may have the same data value. As described above, the non-valid data corresponds to data that, when programmed to the memory cells of the second area, is capable of changing the states of the memory cells to off-cell. According to an embodiment, before providing the data erase command of the first memory block BLOCK1 of the flash memory device 1200, the memory controller 1100 may perform a copy operation by programming valid data and non-valid data included in the respective pages of the first memory block BLOCK1 to the respective pages of the second memory block BLOCK2.

In this manner, even during a copy operation, non-valid data may be programmed to memory cells in second areas corresponding to the pad areas of the page buffer, thus reducing the probability of errors occurring in data subsequently read form the flash memory device and flash memory system.

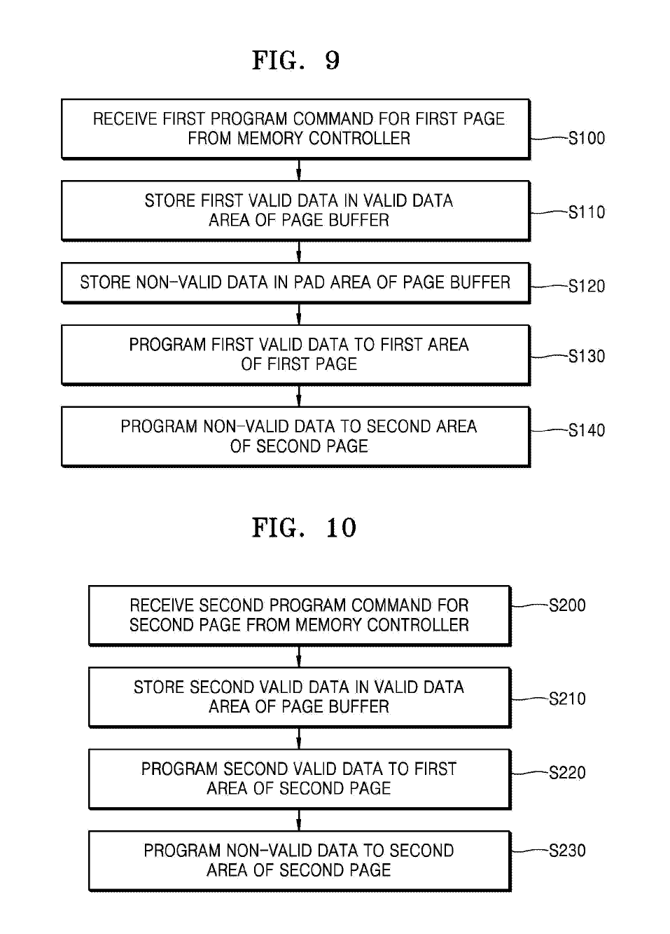

FIG. 9 is a flowchart summarizing a method of operating a flash memory system according to an embodiment of the inventive concept.

As illustrated in FIG. 9, the flash memory device receives a first program command directed to a first page of a flash memory device from a memory controller (S100). Then, control logic loads first (valid) data received from the memory controller in a valid data area of the page buffer in response to the program command using a command generation module of a NAND layer running on the memory controller (S110). The control logic also loads non-valid data in a pad area of the page buffer (S120). Then, the control logic programs the first valid data to memory cells of a first area of the first page corresponding to the valid data area via the page buffer (S130) and programs the non-valid data to memory cells of the second area of the first page corresponding to the pad area through the page buffer (S140). These two last described steps may be simultaneously performed.

FIG. 10 is a flowchart summarizing a method of operating a flash memory system according to another embodiment of the inventive concept.

As illustrated in FIG. 10, following execution of the steps described in relation to FIG. 9, the flash memory device receives a second data program command directed to a second page of the flash memory device from the memory controller (S200). Then, control logic stores second valid data received from the memory controller in the valid data area of the page buffer in response to the second program command and using the command generation module (S210). Here, the non-valid data previously loaded and stored in the pad area is retained. Thus, the control logic programs the second valid data to memory cells of the first area of the second page corresponding to the valid data area through the page buffer (S220), and further logic programs the non-valid data to memory cells of the second area of the second page corresponding to the pad area through the page buffer (S230).

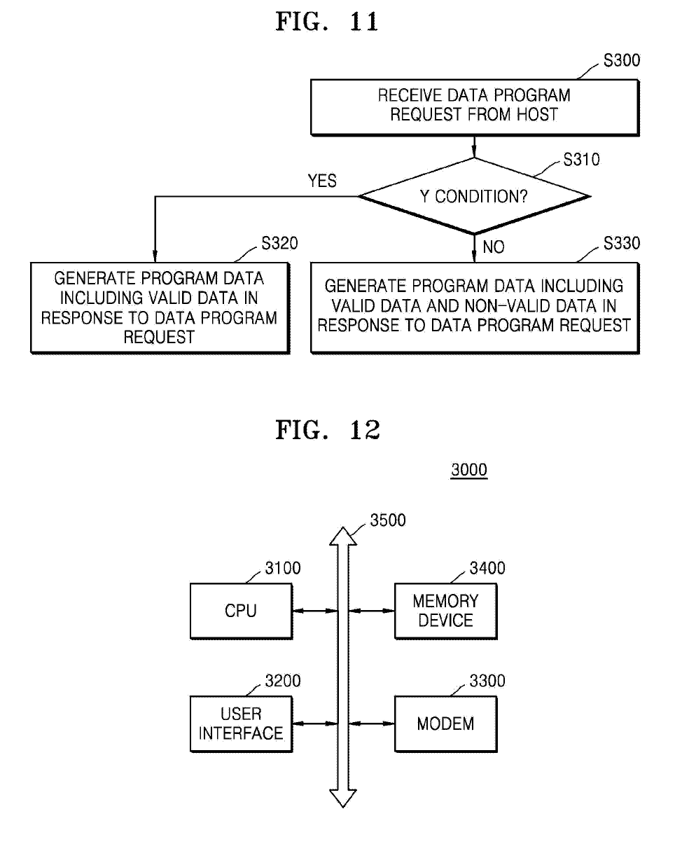

FIG. 11 is a flowchart summarizing a method of operating the flash memory system according to another embodiment of the inventive concept.

Referring to FIG. 11, the memory controller receives a data program request from the host (S300). As described above with reference to FIG. 2, the memory controller determines whether non-valid data should be generated by the operation of the program data generation module, and stores the resulting non-valid data in the pad area of the page buffer (e.g., a Y condition determination—S310). As an example, prior to receiving the data program operation (S300), another data program request may have been received and accordingly non-valid data generated. Thus, in a case where the program data including valid data and non-valid data is generated and stored in the page buffer, the memory controller generates program data including only valid data in response to a data program request, without generating program data including non-valid data (S320). This step (S320) may be performed by disabling the program data generation module. Else, in a case where a data erase request is received prior to operation S300 or in a case where the non-valid data is not stored in the pad area of the page buffer, the memory controller generates non-valid data and generates program data including valid data and non-valid data (S330).

FIG. 12 is a block diagram illustrating a computer system 3000 including a flash memory device according to an embodiment of the inventive concept.

Referring to FIG. 12, the computer system 3000 includes a central processing unit (CPU) 3100, a user interface 3200, a flash memory device 3400, and a modem 3300 such as a baseband chipset, each of which is electrically connected to a system bus 3500. The user interface 3200 may be an interface that transmits data to a communication network or receives data from the communication network. The user interface 3200 may be a wired/wireless type user interface, and may include an antenna or a wired/wireless transceiver. Data, which is provided through the user interface 3200 or the modem 3300 or is processed by the CPU 3100, may be stored in the flash memory device 3400.

The flash memory device 3400 may include a volatile memory device, such as a DRAM), and/or a non-volatile memory device, such as a flash memory. As illustrated in FIG. 1, the flash memory device 3400 may include the page buffer PB, the control logic CL, and the memory unit MU according to the embodiments of the inventive concept. In the program operation, the valid data is stored in the pad area of the page buffer PB, and the non-valid data is programmed to the memory cells of the area corresponding to the pad area among program target pages included in the memory unit MU, thus reducing the error occurrence probability of the flash memory device 3400.

In a case where the computer system 3000 according to an embodiment is a mobile device, a battery (not illustrated) may be additionally provided so as to supply an operating voltage of the computer system 3000. Although not illustrated, the computer system 3000 according to the embodiment may further include an application chipset, a camera image processor (CIP), and an input/output device.

In a case where the computer system 3000 is a system that performs wireless communication, the computer system 2000 may be used in a communication system, such as Code Division Multiple Access (CDMA), Global System for Mobile Communication (GSM), North American Digital Cellular (NADC), and CDMA2000.

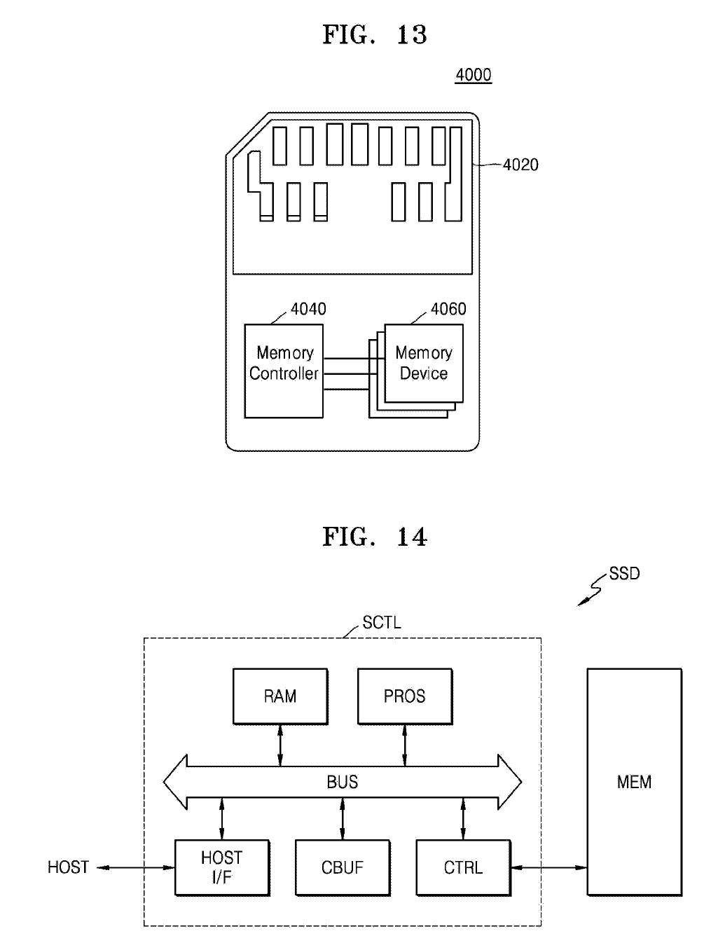

FIG. 13 is a block diagram illustrating a memory card 4000 according to an embodiment of the inventive concept. The memory card 4000 may be a portable storage device that is usable when connected to an electronic device, such as a mobile device or a desktop computer. Referring to FIG. 13, the memory card 4000 may include a memory controller 4040, a memory device 4060, and a port 4020. The memory card 4000 may communicate with an external host (not illustrated) through the port 4020, and the memory controller 4040 may control the memory device 4060. The memory controller 4040 may read a program from a ROM (not illustrated) that stores programs and may execute the read program. The memory controller 4040 and the memory device 4060 of FIG. 13 may be the memory controller and the memory device of FIG. 1 or the like, respectively.

FIG. 14 is a block diagram illustrating a semiconductor storage system according to an embodiment of the inventive concept (e.g., a solid state drive—SSD).

Referring to FIG. 14, the SSD according to the embodiment of the inventive concept includes an SSD controller SCTL and a memory device MEM. The memory device MEM may include the flash memory device of FIG. 1 according to the embodiment of the inventive concept. The SSD controller SCTL may include a processor PROS, a RAM, a cache buffer CBUF, and a memory controller CTRL corresponding to the memory controller of FIG. 1, each of which is connected through a bus The processor PROS may perform control such that the memory controller CTRL performs data transmission and reception with respect to the memory device MEM in response to a request (for a command, an address, or data) from the host and performs the operations according to the embodiments. The processor PROS and the memory controller CTRL of the SSD according to the embodiment of the inventive concept may be implemented using a single ARM processor. Data necessary for the operation of the processor PROS may be loaded into the RAM.

The host interface may receive a request from the host and transmit the received request to the processor PROS or transmit data from the memory device MEM to the host. The host interface may interface with the host through various interface protocols, such as USB, Man Machine Communication (MMC), PCI-E, SATA, Parallel Advanced Technology Attachment (PATA), SCSI, ESDI, and IDE interfaces. Data to be transmitted to the memory device MEM or data transmitted from the memory device MEM may be temporarily stored in the cache buffer CBUF. The cache buffer CBUF may be an SRAM.

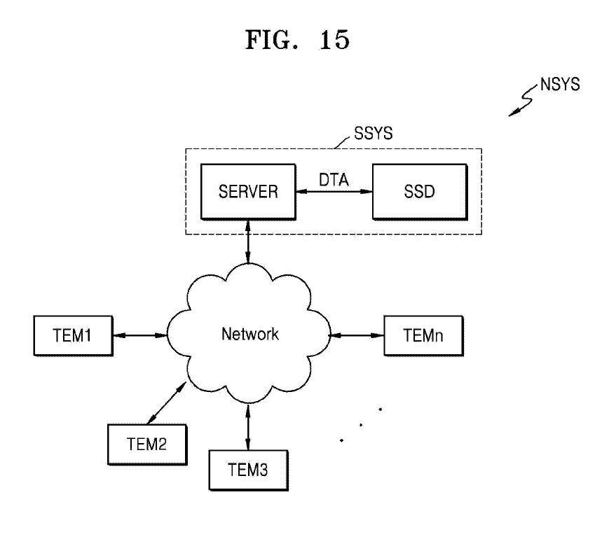

FIG. 15 is a conceptual diagram illustrating a server system and a network system including a semiconductor storage system according to an embodiment of the inventive concept.

Referring to FIG. 15, the network system NSYS includes a server system SSYS and a plurality of terminals TEM1 to TEMn, which are connected through a network. The server system SSYS according to the embodiment of the inventive concept may include a server that processes a request received from the plurality of terminals TEM1 to TEMn connected to the network, and an SSD that stores data corresponding to the request received from the plurality of terminals TEM1 to TEMn. At this time, the SSD of FIG. 15 may be the SSD of FIG. 14.

In various embodiments of the inventive concept, a three dimensional (3D) memory array may be provided. The 3D memory array may be monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an embodiment of the present inventive concept, the 3D memory array includes vertical NAND strings that are vertically oriented such that at least one memory cell is located over another memory cell. The at least one memory cell may comprise a charge trap layer.

Examples of a 3D memory array, in various aspects, are described, for example, in U.S. Pat. Nos. 7,679,133; 8,553,466; 8,654,587; 8,559,235; as well as published U.S. Patent Application 2011/0233648.

While the inventive concept has been particularly shown and described with reference to embodiments thereof, it will be understood that various changes in form and details may be made therein without departing from the scope of the following claims.

What is claimed is:

1. A flash memory device comprising:
control logic that receives an externally-provided first program command with corresponding first program data, and thereafter receives an externally-provided second program command with corresponding second program data;
a memory unit divided into memory blocks, each memory block including a plurality of pages, wherein the plurality of pages includes a first page and a second page, and each of the first page and second page includes a first area designated to store valid data and a second area designated to store non-valid data;
a page buffer including a valid data area and a pad area,
wherein in response to the first program command the control logic causes valid data related to the first program data to be loaded in the valid data area of the page buffer and non-valid data to be loaded in the pad area of the page buffer.

2. The flash memory device of claim 1, wherein the valid data comprises user data received as the first program data, and error detection and/or correct data derived from the first program data.

3. The flash memory device of claim 1, wherein further in response to the first program command the control logic causes the valid data loaded in the valid data area of the page buffer to be programmed in memory cells of the first area of the first page, and the non-valid data loaded in the pad area of the page buffer to be programmed in memory cells of the second area of the first page.

4. The flash memory device of claim 3, wherein following the programming of the memory cells of the second area of the first page, the memory cells of the second area of the first page exhibit an OFF memory cell state.

5. The flash memory device of claim 3, wherein in response to the second program command the control logic causes valid data related to the second program data to be loaded in the valid data area of the page buffer, and the non-valid data loaded in the pad area of the page buffer to be retained in the pad area of the page buffer.

6. The flash memory device of claim 5, wherein further in response to the second program command the control logic causes the valid data loaded in the valid data area of the page buffer to be programmed in memory cells of the first area of the second page, and the non-valid data retained in the pad area of the page buffer to be programmed in memory cells of the second area of the second page without re-loading of non-valid data in the pad area of the page buffer.

7. The flash memory device of claim 6, wherein following programming of the memory cells of the second area of the second page, the memory cells of the second area of the second page to exhibit an OFF memory cell state.

8. The flash memory device of claim 1, wherein the non-valid data is externally provided to the control logic.

9. A NAND flash memory system, comprising:
a flash memory device including control logic, a memory unit divided into memory blocks, each memory block including a plurality of pages, wherein the plurality of pages includes a first page and a second page, and each of the first page and second page includes a first area designated to store valid data and a second area designated to store non-valid data, and a page buffer including a valid data area and a pad area; and
a flash memory controller connected to a host, that receives a first data program request from the host, and thereafter receives a second data program request from the host, the flash memory controller comprising a NAND layer including a program data generation module, wherein in response to the first data program request the flash memory controller generates first program data including first valid data and non-valid data using the data generation module, and in response to the second data program request the flash memory controller generates second program data including second valid data using the data generation module,
wherein in response to the first program data received from the flash memory controller, the control logic of the flash memory device causes the valid data to be loaded in the valid data area of the page buffer and the non-valid data to be loaded in the pad area of the page buffer.

10. The flash memory system of claim 9, wherein the valid data comprises user data received as the first program data, and error detection and/or correct data derived from the first program data.

11. The flash memory system of claim 9, wherein the non-valid data is generated by the program data generation module.

12. The flash memory system of claim 9, wherein the NAND layer further includes a command generation module,
wherein in response to the first data program request the flash memory controller generates a first program command using the command generation module and generates first program data including first valid data and non-valid data using the data generation module, and
in response to the second data program request the flash memory controller generates a second program command using the command generation module and generates second program data including second valid data using the data generation module.

13. The flash memory system of claim 12, wherein further in response to the first data program request the command generation module generates a first program command and in response to the first program command the control logic of the flash memory device causes the first valid data loaded in the valid data area of the page buffer to be programmed in memory cells of the first area of the first page, and the non-valid data loaded in the pad area of the page buffer to be programmed in memory cells of the second area of the first page.

14. The flash memory system of claim 13, wherein in response to the second data program request the command generation module generates a second program command and in response to the second program command the control logic causes the second valid data to be loaded in the valid data area of the page buffer, and the non-valid data loaded in the pad area of the page buffer to be retained in the pad area of the page buffer.

15. The flash memory system of claim 14, wherein further in response to the second program command the control logic causes the second valid data loaded in the valid data area of the page buffer to be programmed in memory cells of the first area of the second page, and the non-valid data retained in the pad area of the page buffer to be programmed in memory cells of the second area of the second page without re-loading of non-valid data in the pad area of the page buffer.

16. The flash memory system of claim 9, wherein the control logic clears data stored in the valid data area and the pad area of the page buffer using a clear operation before loading the first valid data in the valid data area of the page buffer.

17. A method of operating a flash memory device, the method comprising:
receiving a first program command and thereafter receiving a second program command;
in response to the first program command, loading first valid data in a valid data area of a page buffer and loading non-valid data in a pad area of the page buffer;
programming the first valid data loaded in the valid data area of the page buffer to memory cells of a first area of a first page of flash memory and programming the non-valid data loaded in the pad area of the page buffer to memory cells of a second area of the first page;
in response to the second program command, loading second valid data in the valid data area of the page buffer and retaining the non-valid data in the pad area of the page buffer; and
programming the second valid data loaded in the valid data area of the page buffer to memory cells of a first area of a second page of flash memory and programming the non-valid data loaded in the pad area of the page buffer to memory cells of a second area of the second page without re-loading non-valid data in the pad area of the page buffer.

18. The method of claim 17, wherein the first valid data comprises first user data received as first program data with the first program command, and first error detection and/or correct data derived from the first program data, and
the second valid data comprises second user data received as second program data with the second program command, and second error detection and/or correct data derived from the first program data.

19. The method of claim 17, wherein following the programming of the memory cells of the second area of the first page, the memory cells of the second area of the first page exhibit an OFF memory cell state, and
following the programming of the memory cells of the second area of the second page, the memory cells of the second area of the second page exhibit an OFF memory cell state.

20. The method of claim 17, wherein the first page and second page are configured from memory cells arranged in a three-dimensional memory cell array.
